(19) United States
(12) Patent Application Publication
(10) Pub. No.: US 2016/0316800 A1
(43) Pub. Date: Nov. 3, 2016

(54) Metering the Disposition of a Food Product into Cavities Forming a Pellet

(71) Applicants: Karl Linck, Kohler, WI (US); Chay Vue, Sheboygan, WI (US); Craig Hackl, Fond du Lac, WI (US)

(72) Inventors: Karl Linck, Kohler, WI (US); Chay Vue, Sheboygan, WI (US); Craig Hackl, Fond du Lac, WI (US)

(73) Assignee: Zenbury International Limited, Luxembourg (LU)

(21) Appl. No.: 15/172,869

(22) Filed: Jun. 3, 2016

Related U.S. Application Data
(63) Continuation of application No. 13/251,722, filed on Oct. 3, 2011, now abandoned.

(51) Int. Cl. A23L 3/36

(52) U.S. Cl. CPC A23L 3/362; A23L 1/39; A23P 1/105; A23V 2002/00

(57) ABSTRACT

A process for metering the disposition of a food product into cavities forming a pellet. The cavities are defined in one of a conveyor as individual cavities and in a tray moved by the conveyor. Each cavity defines a specific volume. The process includes supplying a quantity of food product in a supply chamber which includes a plurality of nozzles aligned above the conveyor. The nozzles are aligned with a predetermined portion of the cavities. A predefined supply of food product is dispensed and metered through each nozzle. The food product is dispenses through the nozzles into the cavities without exceeding the specific volume of the cavity. The food product is frozen into an individual quick frozen pellet starting immediately upon disposition in one of the cavities. The step of metering the predefined amount of food product includes metering a predetermined weight of the food product.

### CROSS-REFERENCE TO RELATED PATENT APPLICATIONS

This patent application is a continuation of co-pending U.S. patent application Ser. No. 13/251,722, filed Oct. 3, 2011 the entire teachings and disclosure of which are incorporated herein by reference thereto.

### BACKGROUND OF THE INVENTION

1. Field of the Invention

The present invention generally relates to the process for making individual quick frozen pellets composed of a food product. More specifically, the invention relates to providing a portion control fill of cavities in a mold to a specific desired weight and quick freezing each individual food product in the cavity into a pellet.

It is known that various styles of freezing apparatus exists for the creation of sauce pieces frozen from a liquid form. The sauces typically are composed of cheese, vegetables, and various meats in a consistency for food disposition. Some of the freezing apparatus utilize a flat belt onto which specific amounts of sauce are deposited and frozen. Other apparatus use a series of plates or trays that define molded cavities into which a fluid product is filled. Still further apparatus that itself defines cavities into sauce is deposited and frozen.

In a typical operation, the liquid food product is in a open-ended box that sits above a conveyor containing the molds and allows the liquid product to flow into the molds by gravity. The edges of the box then scrape off most of the excess food product with a controlled amount of flash existing between individual frozen pieces. Such flash constitutes waste and such wasted food product may or may not be reusable depending on the particular apparatus and process involved. The cavities filled with the food product is then frozen either in a cryogenic process or more typically in a refrigeration tunnel associated with the filling apparatus.

The process and system of the present invention must also be of construction which is both durable and long lasting, and it should also require little or no maintenance to be provided by the user throughout its operating lifetime. In order to enhance the market appeal of this disclosure, the system should also be of inexpensive construction to thereby afford it the broadest possible market. Finally, it is also an objective that all of the aforesaid advantages and objectives be achieved without incurring any substantial relative disadvantage.

### BRIEF SUMMARY OF THE INVENTION

The disadvantages and limitations of the background art discussed above are overcome by the present disclosure. In one aspect, the invention provides a

There is provided a process for metering the disposition of a food product into cavities for forming a pellet. The cavities are defined in one of a conveyor as individual cavities and in a tray moved by the conveyor. Each cavity defines a specific volume. The process includes supplying a quantity of food product in a supply chamber with the supply chamber including a plurality of nozzles aligned above the conveyor. The plurality of nozzles are aligned with a predetermined portion of the cavities.

A predefined amount of the supply of food product dispensed and metered through each nozzle. The food product is dispenses through one of the nozzles into one of the cavities without exceeding the specific volume of the cavity. The food product is frozen into an individual quick frozen pellet starting immediately upon disposition in one of the cavities. The step of metering the predefined amount of food product includes metering to include a predetermined weight of the food product.

in another embodiment, the process for metering the disposition of the food product includes supplying a second quantity of food product in a second supply chamber having a second plurality of nozzles. The second plurality of nozzles are aligned with the predetermined portion of cavities with the second predefined amount of food product metered and dispenses through each of the second plurality of nozzles into the predetermined portion of the cavities on top of the previously dispensed food product.

It is further provided a system to meter the disposition of the food product into an individual quick frozen pellet. The system includes a conveyor, with the conveyor including cavities, with each cavity defining a specific volume. A quick freeze apparatus is coupled to the conveyor and configured to freeze material defining the cavities. The cavities can be defined in a tray which is supported by and moved by the conveyor, or the cavities can be defined in the conveyor itself The system further includes a supply chamber configured to hold a supply of the food product. The supply chamber includes a plurality of nozzles positioned above the conveyor and aligned with a predetermined portion of the cavities. The nozzles are configured to dispense the food product into the predetermined portion of the cavities without exceeding the individual, specific volume of such cavities and the dispensed food product is frozen starting immediately upon disposition in the cavities.

In another embodiment, the system to meter the disposition of the food product into individual quick frozen pellets further includes a second quantity of food product in a second supply chamber. The second supply chamber is in communication with the plurality of nozzles, aligned above the conveyor with the plurality of nozzles configured to dispense both quantities of food product simultaneously through the same plurality of nozzles into the predetermined portion of cavities.

### BRIEF DESCRIPTION OF THE DRAWINGS

These and other advantages of the present invention are best understood with reference to the drawings, in which:

FIG. 1 is a schematic illustration of a system to meter the disposition of a food product into a tray transported by a conveyor creating individual quick frozen pellets.

FIG. 2 is a perspective view of a portion of the system illustrated in FIG. 1

FIG. 3 is a perspective view of a portion of the system illustrated in FIG. 2 including a distribution manifold and two food supply chambers.

FIG. 4 is an end view of a nozzle configured with two disc a chambers aligned side-by-side.

FIG. 5 is an end view of a nozzle configured with two discharge chambers aligned concentrically.

### DETAILED DESCRIPTION OF THE INVENTION

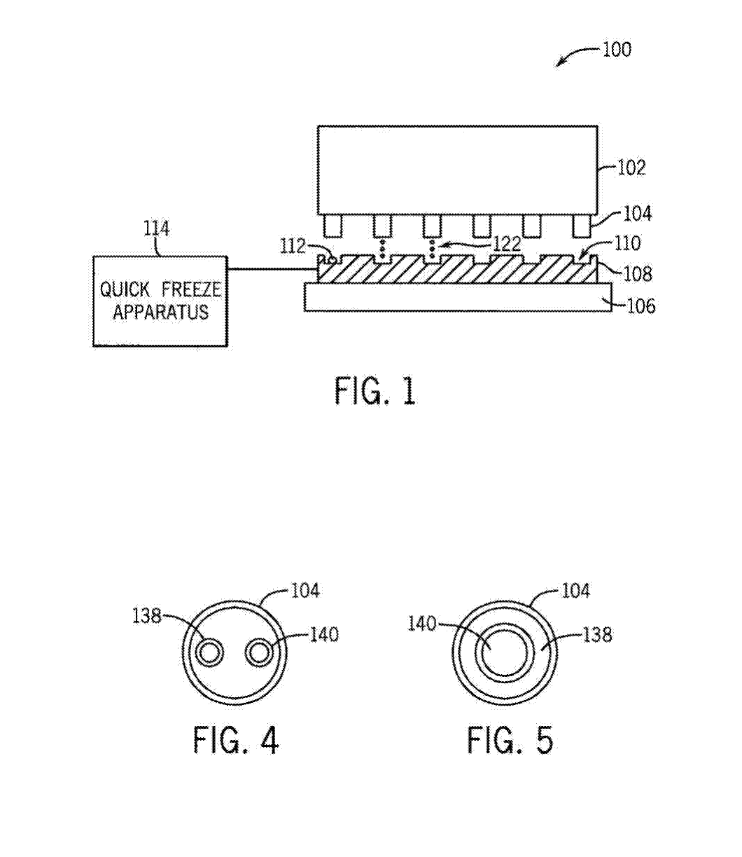

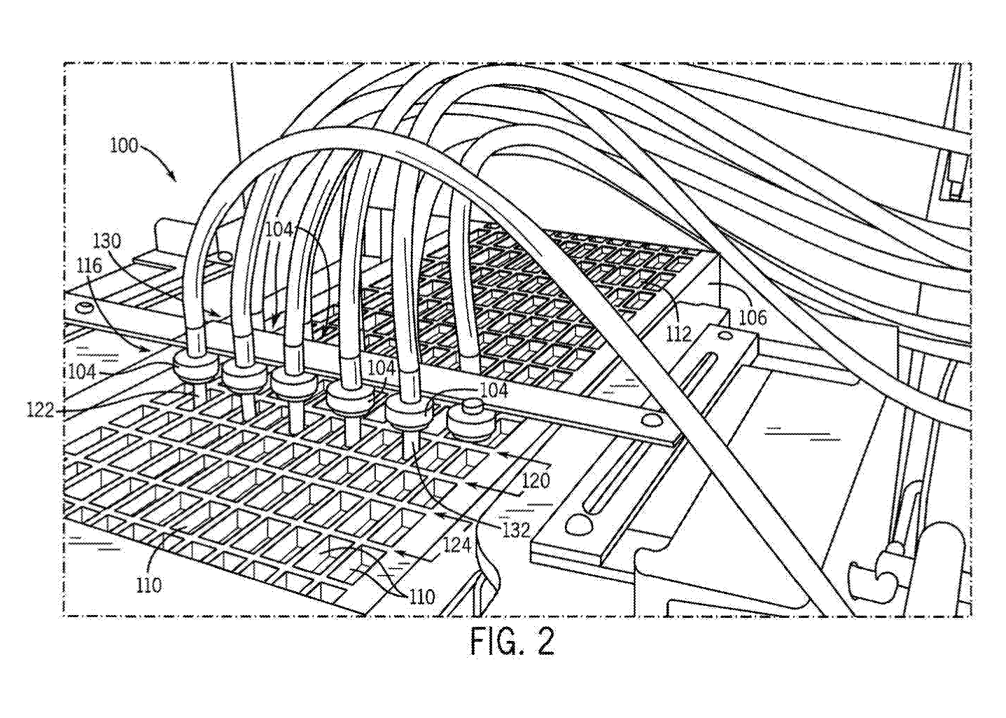

There is disclosed a processing system for metering the disposition of a food product into cavities for forming an individual quick frozen pellet. The process and system provides a portion controlled fill to cavities 110 moving on a conveyor 106 underneath a plurality of nozzles 104, with the nozzles coupled to at least one food product supply chamber 102. The schematic of the system illustrated in FIG. 1 for the system for metering the disposition of food product 100 illustrates a food product supply chamber 102 which includes a plurality of nozzles 104. Each nozzle is in communication with the supply chamber 102 and it is through each nozzle that the portion control of food product is deposited into a predetermined portion of cavities 120 of a corresponding plurality of cavities 110.

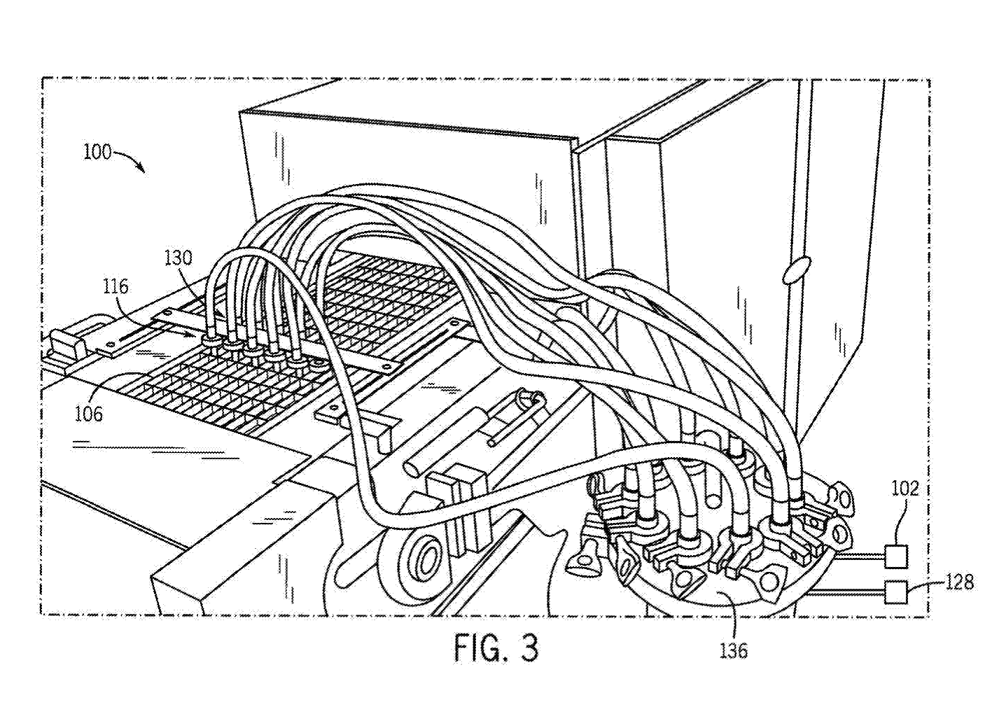

In some embodiments, the cavities 110 are defined in a tray 108 which is supported by and moved by a conveyor 106 (FIG. 1). In another embodiment, the cavity 110 is defined in the conveyor 106 belt itself (FIGS. 3 and 4). The material defining the cavity is typically composed of metal such as stainless steel and in some instances is a two-part construction with a pivot or hinge that allows a pellet 112 contained in the cavity to be removed from the cavity at a dispensing station by flexing the conveyor on tray.

The removal of the pellet from the cavity 110 typically occurs at the end of the fill conveyor line and deposited in a bin or onto another conveyor system for further processing, for example packaging.

The filling of the cavities 110 of the food product 122, 132 occurs in such a. manner that the food product is only filled to the molds without having any product deposited outside of the mold cavities or between the mold cavities as flash. With the present disclosure, there is no need for the food product supply chamber 102 or scrape apparatus to swipe across the tray or conveyor as is typically required in the prior art. It should be understood that a pellet 112 can be configured in any desired shape which is controlled by the shape of the cavity 110 into which the food product is deposited and the amount of food product deposited.

With the present process and system, the filling of a mold or the mold cavity 110 with food product 122, 132 can create exact weight pieces in each of the cavities 110 of the mold. Such arrangement is desirable for a product which may be dispensed by count at the end use, for example the packaging process, with a specific combined weight of the food product. For example if the end product was to contain a one pound package of a specific type of food product pellet 112, with the present process and system, 16 cavities can be filled with 16 1-oz. disposition of food products from the food supply chamber 102 into each cavity 110 creating a pellet 112. Such pellets typically are quick frozen such that at the end of the filling conveyor the cavities are emptied of the 16 pellets and the 16 pellets can be further processed, for example additional freezing, or packaged into the desired 1 lb. package, for example a bag. Since there would be no flash associated with this process and system, the tray 108 or conveyor 106 defining the cavities 110 would be in a condition for immediate continued use since no flash or overfill would have to be cleaned or removed.

The present process and system also provides the ability to deposit different predetermined weight of food products in a predetermined portion of cavities 120, 124 in the tray or on the conveyor. The different weight of the food product pellet 112 in the different portion of cavities, can be separated at the end of the fill conveyor line to provide flexibility in creating end user packaging with the different weighted pellets. Such purposeful difference in weight creates a statistically significant difference to allow a computerized combination or weighing scale the ability to better make exact dispensing weights of the frozen pellets into subsequent packages or meal kits of the specific food product.

In another embodiment, the process and system provides that a second quantity of food product 132 in a second supply chamber 128 having a second plurality of nozzles 130 are aligned over the conveyor containing the cavities. The second plurality of nozzles 130 are aligned with the predetermined portion of cavities 124 metering the second predetermined amount of food product 122 and dispensing the second quantity of food product through each of the second plurality of nozzles into the predetermined portion of cavities on top of the previously dispensed food product. In this embodiment, using more than one filler to provide a sequential style of fill allows multiple liquid ingredients to be layered into a final individual quick frozen pellet 112,

It is also contemplated, with the above-described embodiment, that the dispensing of a solid food product, for example a small carrot cube into a cavity prior to the liquid sauce in the second supply 128 chamber and nozzle system deposits the sauce into the same cavity as the carrot piece. Such arrangement encapsulates the carrot piece or pieces into a single pellet. It is also possible, with this embodiment, that the fluid sauce is deposited in the cavity first and then the solid piece of food product from the second supply chamber 128 is deposited on top of the first deposited food product.

The present system 100 provides for a quick freeze apparatus 114 coupled to one of the conveyor 106 and tray 108 system defining the plurality of cavities 110. This system, cryogenically refrigerates the conveyor belt 106 or the tray 108 moved by the conveyor, for example liquid nitrogen such that when the food product is deposited into the cavity the freezing of the food product into an individual quick frozen pellet starts immediately upon disposition in the cavities 110. It should be understood that a final hard freeze does not occur to the entire pellet until it is discharged from the pellet portion of the freezer and then goes through a more traditional belt freezer to get the core fully frozen. However, edge freezing of the food product, that portion of the food product in immediate contact with the material defining the cavity, occurs on contact of the food product with the edge of the cavity, This freezing progresses towards the core of the pellet, while other freezing occurs to the top of the pellet due to liquid nitrogen being introduced to the top of the pellet in some configurations. Conduction on the sides of the cavity also tends to freeze the food product upon disposition of the food product into a cavity.

in another embodiment, each of the nozzles 104 includes at least two separate discharge chambers 138, 140 with each chamber in communication with one of a quantity of food products 102, 128. In one configuration, the two discharge chambers 138, 140 are aligned side by side (FIG. 4) and in another configuration the two discharge chambers are aligned concentrically (FIG. 5), Such nozzles are configured to dispense the two quantities of food product simultaneously through the same plurality of nozzles into the predetermined portion of cavities on or in the conveyor 106. Such simultaneous discharge of the food products into the same cavity provides a marbling effect. A distribution manifold 136 is coupled to the food supply chambers 102, 128 and facilitates distribution to the predetermined nozzles for dispensing of the food product. Appropriate pumps, conduits, tubes and related equipment are coupled to the distribution manifold 136. An exemplary distribution manifold is illustrated in FIG. 3. The distribution manifold 136 can be any suitable and convenient mechanism configured to distribute the food product to the desired nozzles.

It should be understood that any number of supply chambers 102 can be coupled to the manifold 136 and provide food product above a conveyor 106 in dispensing different food products into different portions of cavities 120, 124 moving underneath the nozzles. This allows an operator to fill different mold cavities with different combinations of food products within different molds as determined by the operator. The disposition of the food product through the plurality of nozzles 104 can be by gravity or under pressure, such as a spray liquid filler in combination with either a liquid filler or solid filler. A valve apparatus is associated with each nozzle to control the predetermined amount of food product disposed into a cavity.

It is also contemplated that the system and process can be controlled by a controller coupled to the system that controls the amount, weight, combination of food products being deposited in specific cavities or groups of cavities as determined by an operator.

It is contemplated, the process and system of the present disclosure provides that the quantity of food product can be one of a solid food product or a viscous food product. For example, the food product can be one of a cheese sauce, a vegetable sauce, and a meat sauce. For further example, an individual quick frozen pellet can be a homogenous pellet of each sauce to give a blend of marinara, parmesan, and a garlic sauce in a machine at the end of the filler conveyor.

The present process and system for metering the disposition of the food product into cavities to form a pellet provides the ability to create exact weight pellets, create exactly random weight pellets to improve filling accuracy with a computerized combinational weighing scale. The process and system also provides for the creation of pellets with both viscous and nonviscous food products and to create food pellets with multiple liquid and solid ingredients.

For purposes of this disclosure, the term “coupled” means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

Although the foregoing description of the present process and system has been shown and described with reference to particular embodiments and applications thereof, it has been presented for purposes of illustration and description and is not intended to be exhaustive or to limit the disclosure to the particular embodiments and applications disclosed, It will be apparent to those having ordinary skill in the art that a number of changes, modifications, variations, or alterations as described herein may be made, none of which depart from the spirit or scope of the present disclosure. The particular embodiments and applications were chosen and described to provide the best illustration and its practical application to thereby enable one of ordinary skill in the art to utilize the disclosure in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

What is claimed is:

1. A process for metering the disposition of a food product into cavities for forming a pellet, the cavities are defined in one of a conveyor as individual cavities and in a tray moved by the conveyor, with each cavity defining a specific volume, the process comprising:
supplying a quantity of food product in a supply chamber, wherein the supply chamber includes a plurality of nozzles aligned above the conveyor;
aligning the plurality of nozzles with a predetermined portion of the cavities;
metering a predefined amount of the supply of food product dispensed through each nozzle;
dispensing the food product through one of the nozzles into one of the cavities without exceeding the specific volume of the cavity;
cryogenically refrigerating the conveyor when the individual cavities are empty prior to the step of dispensing; and
freezing the food product into an individual quick frozen pellet starting immediately upon disposition in one of the cavities.

2. The process for metering the disposition of a food product of claim 1, further comprising the step of metering to include a predetermined weight of the food product.

3. The process for metering the disposition of a food product of claim 2, wherein each cavity of the predetermined portion of the cavities receives a different predetermined weight of the food product.

4. The process for metering the disposition of a food product of claim 1, further comprising supplying a second quantity of food product in a second supply chamber having a second plurality of nozzles, aligning the second plurality of nozzles with the predetermined portion of the cavities, metering the second predefined amount of food product, and dispensing the second quantity of food product through each of the second plurality of nozzles into the predetermined portion of cavities on top of the previously dispensed food product.

5. The process for metering the disposition of a food product of claim 1 wherein the quantity of food product is one of a solid food product and a viscous food product.

6. The process for metering the disposition of a food product of claim 4, wherein the second quantity of food product is one of a solid food product and a viscous food product.

7. The process for metering the disposition of a food product of claim 1, further comprising supplying a second quantity of food product in a second supply chamber in communication with the plurality of nozzles aligned above the conveyor with the plurality of nozzles configured to dispense both quantities of food product simultaneously through the same plurality of nozzles into the predetermined portion of cavities.

8. The process for metering the disposition of a food product of claim 7, wherein each nozzle of the plurality of nozzles comprises two separate discharge chambers with each chamber in communication with one of the quantity of food products.

9. The process for metering the disposition of a food product of claim 8, wherein the two discharge chambers are aligned side-by-side.

10. The process for metering the disposition of a food product of claim 8, wherein the two discharge chambers are aligned concentrically.

11. The process for metering the disposition of a food product of claim 1, further comprising supplying a second quantity of food product in a second supply chamber having a second plurality of nozzles, aligning the second plurality of nozzles with a second predetermined portion of the cavities, metering the second predefined amount of food product, and dispensing the second quantity of food product through each of the second plurality of nozzles into the second predetermined portion of cavities.

12. The process for metering the disposition of a food product of claim 1, wherein the food product is one of a cheese sauce, vegetable sauce, and a meat sauce.

13. The individual quick frozen food product pellet manufactured by the process of claim 1.

14. A system to meter the disposition of a food product into an individual quick frozen pellet, the system comprising:
a conveyor, with the conveyor including cavities, with each cavity defining a specific volume;
a quick freeze apparatus coupled to the conveyor and configured to the cavities;
a supply chamber configured to hold a supply of the food product, the supply chamber includes a plurality of nozzles positioned above the conveyor and aligned with a predetermined portion of the cavities, wherein the nozzles are configured to dispense the food product into the predetermined portion of the cavities without exceeding the individual, specific volume of such cavities and the dispensed food product freezes starting immediately upon disposition in the cavities; and
wherein the quick freeze apparatus is arranged relative to the nozzles such that cavities of the conveyor are cryogenically refrigerated by the quick freeze apparatus when the cavities are empty.

15. A system to meter the disposition of a food product into an individual quick frozen pellet of claim 14, further comprising:
a second supply chamber configured to hold a second supply of the food product, the second supply chamber includes a second plurality of nozzles positioned above the conveyor and aligned with the predetermined portion of the cavities, wherein the nozzles are configured to dispense the second food product into the predetermined portion of the cavities without exceeding the individual, specific volume of such cavities on top of the preciously dispended food product.

16. The system to meter the disposition of a food product into an individual quick frozen pellet of claim 14, wherein the quantity of food product is one of a solid food product and a viscous food product.

17. The system to meter the disposition of a food product into an individual quick frozen pellet of claim 15, wherein the second quantity of food product is one of a solid food product and a viscous food product.

18. The system to meter the disposition of a food product into an individual quick frozen pellet of claim 14, further comprising a second quantity of food product in a second supply chamber in communication with the plurality of nozzles aligned above the conveyor with the plurality of nozzles configured to dispense both quantities of food product simultaneously through the same plurality of nozzles into the predetermined portion of cavities.

19. The system to meter the disposition of a food product into an individual quick frozen pellet of claim 18, wherein each nozzle of the plurality of nozzles comprises two separate discharge chambers with each chamber in communication with one of the quantity of food products.

20. The system to meter the disposition of a food product into an individual quick frozen pellet of claim 19, wherein the two discharge chambers are aligned side-by-side.

21. The system to meter the disposition of a food product into an individual quick frozen pellet of claim 19, wherein the two discharge chambers are aligned concentrically.

22. The system to meter the disposition of a food product into an individual quick frozen pellet of claim 14, further comprising a second quantity of food product in a second supply chamber, the second chamber having a second plurality of nozzles aligned with a second predetermined portion of the cavities above the conveyor with the second plurality of nozzles configured to dispense the second quantity of food product into the second predetermined portion of cavities.

23. The system to meter the disposition of a food product into an individual quick frozen pellet of claim 14, wherein the cavities are defined in one of a conveyor as individual cavities and in a tray moved by the conveyor.
